(19) United States
(12) Patent Application Publication
(10) Pub. No.: US 2007/0199425 A1
(43) Pub. Date: Aug. 30, 2007

(54) Horn

(76) Inventor: Roberto Riber Arzabala, Madrid (ES)

Correspondence Address: SUGHRUE MION, PLLC, 2100 PENNSYLVANIA AVENUE, N.W., SUITE 800, WASHINGTON, DC, 20037, US

(21) Appl. No.: 10/573,026

(22) PCT Filed: Sep. 26, 2003
(86) PCT No.: PCT/ES03/00490

§ 371 Date: Jan. 17, 2007

(51) Int. Cl. G10F 1/12

(52) U.S. Cl. 84/83

(57) ABSTRACT

The invention relates to a horn comprising a one-piece body which is preferably made from an injected plastic material. The aforementioned body defines a cylindrical tube (1) forming the acoustic chamber, the free end (1′) of which is flared. In addition, the tube (1) is surrounded by a coaxial wall (6) having a semi-spherical or similar configuration, which forms a pressure chamber (7) with a corresponding blow tube (8). According to the invention, the periphery of a vibrating sheet (9) is fixed to the mouth of the wall (6) by means of heat sealing. The vibrating sheet, which is made from laminated aluminium, adopts a curved configuration such as to be housed in the end of the tube (1) forming the acoustic chamber (5), said end extending slightly beyond the mouth of the wall (6) forming the pressure chamber (7).

### OBJECT OF THE INVENTION

The present invention refers to a horn or whistle, that is, an acoustic generation element that can be used as a signaling device in any type of sea or land vehicle, but likewise able to be used in any other practical case which requires sound generation, such as parties, sporting events, etc.

### BACKGROUND OF THE INVENTION

One of the solutions when structuring a horn is to create therein a pressure chamber and an acoustic chamber connected to one another through a vibrating membrane, such that the air supplied to the pressure chamber either with the mouth or with a compressed air generating apparatus makes the membrane vibrate, with the corresponding acoustic generation, the volume of which is enhanced and modulated in the acoustic chamber.

European patent with application number EP-A-9293095 can be mentioned in this sense, wherein a horn for sports fans is disclosed, structured by means of cylindrical and coaxial tubes which are fixed and closed at one of their ends with the collaboration of a locking ring and at their other end receive a membrane which is supported on the opening of the inner tube or acoustic tube and fixed to the opening of the outer tube or pressure tube with the collaboration of a retaining ring.

This solution has drawbacks which are mainly focused on the following aspects:
The membrane fixing operation must be carried out manually, with pronounced fixing pressure, making the entire assembly process extremely slow and furthermore providing no homogeneity in the tension of the membrane of different horns.
The membrane is weak and its working life is relatively short.
The configuration of the pressure chamber is not the most suitable for another type of membranes, and the general assembly of the horn is relatively complicated.
Nor is the cylindrical configuration of the acoustic tube the most suitable for achieving optimal results from the acoustic point of view.

### DESCRIPTION OF THE INVENTION

The horn proposed by the invention resolves in a fully satisfactory manner the drawbacks set forth above in the different aspects discussed.

To that end and more specifically, said horn has as one of its fundamental features the fact that the vibrating strip is a metal strip, specifically of plastic coated aluminum, which is brought close to the corresponding end of the acoustic chamber and in turn fixed to the corresponding end of the partition forming the pressure chamber. The fixing of this membrane can be carried out by different methods, fixing by ultrasonic welding or by means of heat sealing being preferable.

The plastic coated aluminum used in making the vibrating strip very substantially prolongs its duration and resistance, whereas its fixing without needing prior tensing on the horn allows automating the manufacture of the latter since the strip can be applied in a machined manner, that is without manual participation for this purpose, and assuring a perfect sound homogeneity in all the horns since the conditions for fixing the vibrating strip will be the same in all of them.

In order to improve the conditions for fixing the vibrating strip to the horn body, it has been provided that the corresponding free edge of the partition forming the pressure chamber is grooved, which improves the attachment of the plastic coated aluminum during fixing by heat sealing.

The other preferred fixing alternative by means of ultrasonic welding requires a slightly different configuration of the horn body. In this case only one part of the corresponding end of the partition forming the pressure chamber, where the strip will be fixed by means of ultrasonic welding, is grooved. The rest of the partition of the pressure chamber, and specifically its outer portion, is not grooved but rather is an extension of the outer partition forming the pressure chamber. Once the strip is fixed to the top portion of the pressure chamber, the previous extension of the outer wall of the pressure chamber is bent, preferably by means of ultrasonic welding, over the previously fixed strip. The strip is thus perfectly fixed to the horn body without the risk of said strip being lost or losing tension.

It is also likewise possible to combine both fixing processes, i.e. fixing by heat sealing the strip and the later bending of the outer wall of the pressure chamber by ultrasound, or just fixing the membrane by ultrasonic welding.

According to another feature of the invention, the horn has a one-piece body, i.e. the tube forming the acoustic chamber is one piece with the tube forming the pressure chamber, therefore eliminating the classic locking ring, as well as the fixing operation between the two horn bodies.

It has also been provided that the partition constituting the pressure chamber is included in an imaginary semi-spherical or semi-ellipsoidal surface, which on one hand favors the manufacture of the horn as it facilitates the demolding of its body and increases the sound emitted by it, since there is a large contact surface between the membrane and pressure chamber, facilitating the vibration of the strip by introducing air through a blow tube communicating the pressure chamber with the exterior.

It has also been provided that the tube forming the acoustic chamber housed inside the partition forming the pressure chamber slightly projects with respect to the opening of the latter, for which purpose the vibrating strip adopts a notably curved configuration, in the manner of a very leveled cap.

The acoustic tube extends at its end opposite to the membrane in the shape of a trumpet, which also aids in enhancing the sound emitted by the horn.

It is possible to incorporate a T-shaped body joining two horns, and the air is introduced in both horns through the free end of the auxiliary T-shaped part. It is possible for this part to have its free end or air introduction end configured with holes such that it works like a flute.

### DESCRIPTION OF THE DRAWINGS

To complement the description being made and for the purpose of aiding to better understand the features of the invention, according to a preferred embodiment thereof, a set of drawings is attached as an integral part of said description in which the following is shown with an illustrative and non-limiting character:

FIG. 1 shows a schematic perspective view of a horn carried out according to the object of the present invention.

FIG. 2 shows a side elevational sectional view of the same horn with an enlarged detail at the level of the area of fixing the vibrating strip to the horn body.

### PREFERRED EMBODIMENT OF THE INVENTION

In view of the discussed figures, it can be observed how the horn proposed by the invention is formed by means of a one-piece body, preferably injected in plastic material, in which a tubular area (1) is defined with a first cylindrical section corresponding with reference (1) itself, and a second bell-mouthed section (1′), configured in the manner of a trumpet with a free end (4), said body (1-1′) in either case configuring the acoustic chamber (5) of the horn.

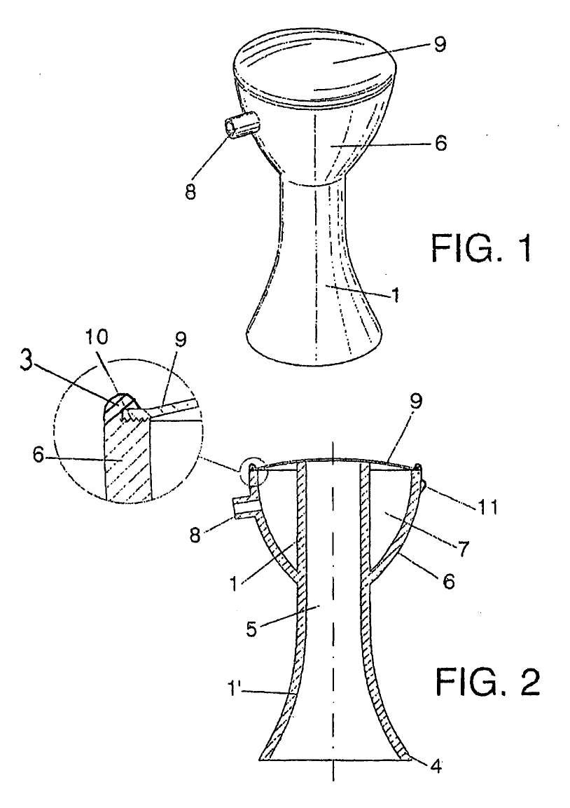

The cylindrical section (1) of this tubular area is coaxially housed inside an enclosing partition (6) having a semi-spherical or semi-ellipsoidal configuration, defining with area (1) itself the pressure chamber (7) with its classic blow tube (8), with the particularity that the free edge of said partition (6) is notably drawn in with respect to the free end of section (1) of the body forming the acoustic chamber (5), as can be particularly observed in FIG. 1, so as to allow the tensing of the strip at assembly time.

The described structure is complemented with the inevitable vibrating strip (9) which in this case has the special particularity of being metallic, specifically of plastic coated aluminum, adopting the configuration of a considerably leveled spherical cap and fixed to the opening of the partition (6).

If the fixing is carried out by heat sealing, the opening of the partition (6) will be provided with grooves (10) along its entire width improving the effects of the heat sealing, assuring optimal fixing of the vibrating strip (8) to the horn body.

If the fixing is carried out by means of ultrasonic welding, the grooves (10) will only be extended along one portion of the width of the opening of the partition (6), the rest of the width remaining as an extension (3) of said partition (6). Once the strip (9) is fixed to the opening of the partition (6), the extension (3) of the latter is bent towards the inside of the horn body and over the strip (9), in the manner of a rivet, assuring the fixing of the strip (9) to the horn body.

A small loop, ring or the like (11) facilitates hanging the horn preferably from a cord or string.

All that remains is to finally point out that the possibility of coupling two horns in parallel has been provided, joining them in an attached or non-removable manner with the collaboration of an auxiliary tubular T-shaped part, not shown in the drawings. It is also possible that the free end of the auxiliary T-shaped part has at least one hole and preferably three, granting the horn trumpet features.

1. A horn of the type comprising a blow tube and coaxial pressure and acoustic chambers between which a vibrating strip is arranged, wherein said vibrating strip consists of a plastic coated aluminum strip that is coaxial with the acoustic chamber and fixed at its periphery to the free edge of the partition forming the enclosing or pressure chamber.

2. The horn according to claim 1, wherein the opening of the partition of the pressure chamber which the vibrating strip is fixed to is notably drawn in with respect to the free end of the cylindrical tube forming the pressure chamber.

3. The horn according to claim 1, wherein the acoustic chamber and the pressure chamber form a one-piece body in which a tubular and cylindrical area configures the acoustic chamber, whereas a cap-shaped area configures the pressure chamber, which envelopes the former and is coaxial with it.

4. The horn according to the claim 1, wherein the area of the body forming the acoustic chamber, in its section opposite to the pressure chamber, adopts a bell-mouthed configuration, in the manner of a trumpet, divergent towards its free end.

5. The horn according to claim 1, wherein the vibrating strip is fixed to the free edge of the partition forming the pressure chamber by means of ultrasonic welding.

6. The horn according to claim 1, wherein the vibrating strip is fixed to the free edge of the partition forming the pressure chamber by means of heat sealing.

7. The horn according to claim 1, wherein the opening of the partition forming the pressure chamber has at least part of the surface of its edge grooved so as to favor the attachment of the vibrating strip.

8. The horn according to the claim 1, wherein the opening of the partition forming the pressure chamber has an extension of the partition of the pressure chamber in its outer area, said extension being bent over the vibrating membrane once it has been fixed to the horn body.

9. The horn according to the claim 1, wherein collaborating with it is an also tubular auxiliary T-shaped part connected to the blow tubes such that it removably and non-removably couples two horns together, leaving a common outlet free.

10. The horn according to claim 9, wherein the common outlet of the T-shaped auxiliary part has at least one hole in the manner of a flute.

11. The horn according to claim 3, wherein the cap is semi-spherical.

12. The horn according to claim 3, wherein the cap is semi-ellipsoidal.

13. The horn according to the claim 1, wherein it has a small loop, ring or the like.
